(19) United States
(12) Patent Application Publication
(10) Pub. No.: US 2007/0247555 A1
(43) Pub. Date: Oct. 25, 2007

(54) Delivery system for dispensing volatile materials with high level of solids using an electromechanical transducer device

(76) Inventors: Steven Louis Diersing, Cincinnati, OH (US); Jonathan Robert Cetti, Mason, OH (US); John Philip Hecht, West Chester, OH (US); Fernando Ray Tollens, Loveland, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/408,447

(22) Filed: Apr. 21, 2006

(51) Int. Cl. G02F 1/1335

(52) U.S. Cl. 349/6

(57) ABSTRACT

A delivery system or apparatus for the production, evaporation or release of volatile materials, wherein the volatile material contains a high level of solids to enhance intensity, character and/or substantivity of a perfume presentation or other fluid property. By providing a formulation with a relatively higher level of solids, an increase in intensity, perceived character and substantivity may be achieved. The system may be capable of battery operation and/or use an open capillary tube to deliver the volatile material from a reservoir to a transducer.

### FIELD OF THE INVENTION

The present invention relates to delivery systems for emitting droplets of liquid active materials, and to high solids liquid compositions therefor.

### BACKGROUND OF THE INVENTION

A number of processes exist for the generation of droplets using electromechanical actuation. One method for such distribution is to atomize a liquid by a device comprising a perforate structure which is vibrated by an electromechanical transducer which has a composite thin-walled or planar structure, and is arranged to operate in a bending mode. Liquid is supplied to the vibrating perforate structure and sprayed therefrom in droplets upon vibration of the perforate structure. See the illustrative attempts in the art, such as U.S. Pat. Nos. 3,543,122, 3,615,041, 4,479,609, 4,533,082, 4,790,479, 5,518,179, 5,297,734, 6,341,732, 6,378,780, and 6,386,462,

Thus, a need exists for improved atomizers or dispensers for use in the delivery and distribution of active fluids such as fragrances and other volatile ingredients.

### SUMMARY OF THE INVENTION

The invention comprises a device for generating droplets of a liquid. The device comprises a reservoir containing a liquid formulation, an electromechanical transducer in fluid communication with the reservoir, and a power supply for exciting the transducer. The fluid has a solids content ranging from about 3 to about 30 percent.

The disclosure of all patents, patent applications and publications cited herein are incorporated herein by reference. It is expressly not admitted, however, that any of the documents incorporated by reference herein teach or disclose the present invention.

### DETAILED DESCRIPTION OF THE INVENTION

This invention relates to delivery systems or apparatus for emitting droplets of liquid active materials such as perfumes, other volatile liquids and/or volatile materials. The volatile material may provide a hedonic benefit, which may be increased by the presence of solid perfume components.

The volatile materials may be emitted in various facilities, which include but are not limited to rooms, houses, hospitals, offices, theaters, buildings, and the like, or into various vehicles such as trains, subways, automobiles, airplanes, the outdoors and the like.

The terms “volatile materials”, “aroma”, and “scents”, as used herein, include, but are not limited to pleasant or savory smells, and, thus, also encompass scents that function as fragrances, deodorizers, odor eliminators, malodor counteractants, insecticides, insect repellants, medicinal substances, air fresheners, deodorants, aromacology, aromatherapy, or any other odor that acts to condition, modify, or otherwise charge the atmosphere or to modify the environment.

In addition, the term “volatile materials” as used herein, refers to a material or a discrete unit comprised of one or more materials that is vaporizable, or comprises a material that is vaporizable without the need of an energy source. Any suitable volatile material in any amount or form may be used. The term “volatile materials” includes but is not limited to compositions that are comprised entirely of a single volatile material. It should be understood that the term “volatile material” also refers to compositions that have more than one volatile component, and it is not necessary for all of the component materials of the volatile material to be volatile. The volatile materials described herein may, thus, also have non-volatile components.

It should also be understood that when the droplets of liquid active materials are described herein as being “emitted” or “released,” this refers to the volatilization of the evaporative components of the volatile materials and to the release to the environment of the non-evaporative components, which may be small solids or particulates. The volatile materials of interest herein can be in any suitable form including, but not limited to: dispersion of solids, emulsions, liquids, and combinations thereof. For example, the delivery system may contain a volatile material comprising a single-phase composition, multi-phase composition and combinations thereof, from one or more sources in one or more carrier materials (e.g. water, solvent, etc.).

The volatile material may comprise a perfume, although the invention is not so limited. A perfume may include a single aromatic chemical or a mixture of aromatic chemicals. As used herein, aromatic chemicals mean chemicals that have an odor. There are several chemical classes which fall within aromatic chemicals, including but not limited to ionones, hydrocarbons, alcohols, aldehydes, ketones, esters, etc.

The term fragrance or perfume refers to all organic substances which have a desired olfactory property and are essentially nontoxic. They can be compounds of natural, semisynthetic, or synthetic origin. A fragrance can be a combination of various odorous substances which evaporate at different rates and/or during different periods. Fragrance can exhibit what is known as a “top note,” which may be the odor which first diffuses when the fragrance is applied, emitted or released to the environment, a “heart note” or “middle note,” which may complete or complement the fragrance providing body and texture, and a “base note,” which may be the most substantive odor and can be perceived several hours after application or emission.

In order to be noticeable, a perfume has to be volatile, its molecular weight being an important factor along with the nature of the functional groups and the structure of the chemical compound. Thus, most perfumes have molecular weights of up to about 200 Dalton, with molecular weights of 300 Dalton and higher being more the exception. In view of the differences in volatility of perfumes, the odor of a perfume or fragrance composed of several perfumes changes during the evaporation process, the odor impressions being divided into the top note, the middle note or body and the base note.

The perfume, or other liquid fluid, according to the present invention may have a predetermined solids content. The solids content may be at least about 3 percent, about 4 percent, about 5 percent, about 6 percent, about 10 percent, about 15 percent or about 20 percent. If desired, the solids content of the perfume or other liquid fluid according to the present invention may be less than about 30 percent, about 25 percent or about 20 percent. Unless otherwise specified, all percentages disclosed herein are on a weight percentage basis.

The term “solids” as used herein, refers to a material that has a tangible or concrete form as discrete material at room temperature (22° C.), that is, they tend to keep their form rather than flow or spread out like liquids or gases. The solids may be dissolved in the formulation or suspended throughout. Solids may behave very similar to base notes as they bring depth and body to a perfume.

Since odor perception is also based to a large extent on odor intensity, the top note of a perfume or fragrance may not consist solely of readily volatile compounds. The base note may consist largely of less volatile, i.e. firmly adhering, perfumes. In the composition of perfumes, more readily volatile perfumes may be fixed, for example, to certain “fixatives”, which prevents them from vaporizing too rapidly. The perfume may also contain small amounts of other additives, such as solvents, preservatives, antioxidants, UV screening agents and the like. The fragrance matrix may also include organoleptic components, such as for example, other well-known fragrance ingredients.

The fragrances or perfumes may include natural and/or synthetic oils, extracts and/or essences which may comprise complex mixtures of constituents, such as orange oil, lemon oil, rose extract, lavender, musk, patchouli, balsam essence, sandalwood oil, pine oil, and cedar oil. A useful term to quantify the degree of volatility of the volatile materials is the Kovat's Index. The Kovat's Index (KI, or Retention Index) may be defined by the selective retention of solutes or perfume raw materials (PRMs) onto the chromatographic columns. It is primarily determined by the column stationary phase and the properties of solutes or PRMs. For a given column system, a PRM's polarity, molecular weight, vapor pressure, boiling point and the stationary phase property determine the extent of retention. To systematically express the retention of analyte on a given GC column, a measure called Kovat's Index is defined. The Kovat's Index places the volatility attributes of an analyte (or PRM) on a column in relation to the volatility characteristics of n-alkane series on that column. Typical columns used are DB-5 and DB-1.

By this definition the KI of a normal alkane may be set to 100n, where n=number of C atoms of the n-alkane. With this definition, the Kovat's index of a PRM, x, eluting at time t′, between two n-alkanes with number of carbon atoms n and N having corrected retention times t′n and t′N respectively will then be calculated as:

$$KI = 100 ⨯ ( n + \frac{log {t}_{x}^{′} - log {t}_{n}^{′}}{log {t}_{N}^{′} - log {t}_{n}^{′}} ) \qquad ( 1 )$$

This equation can be used to calculate the Kovat's index for any volatile material. Furthermore, this equation can be used to further separate volatile components into three categories; top, middle and base notes. Using the Kovat's index, a top note may as have a KI less than or equal to 1200, a middle note between 1200 and 1400, and a base note greater than or equal to 1400. For example, a typical perfume formulation having 2 percent solids may comprise 70 percent top notes, 20 percent middle notes, and 10 percent bottom notes. A comparable formulation having about 3 percent solids may comprise about 40 to about 60 percent, particularly about 50 percent top notes; about 20 to about 40 percent, particularly about 30 percent middle notes; and about 10 to about 30 percent, particularly about 20 percent bottom notes.

The perfume, volatile material or other liquid according to the present invention may be placed in an open container or other vessel, allowing natural evaporation to occur. Alternatively, the perfume, volatile material or other liquid may be dispensed to the atmosphere using a known delivery system or apparatus, having a suitable mechanical transducer. In another embodiment a heater may be utilized to assist in and accelerate the evaporation.

The delivery system may comprise a reservoir for containing the liquid. The liquid may be delivered or otherwise communicated from the reservoir to an electromechanical transducer. The transducer may be driven with an oscillating voltage at one of the resonant frequencies of the system or alternatively with a waveform that gives drop-on demand operation. The oscillating voltage may produce a vibration in the transducer. The vibration may, in turn, move a perforate structure operatively associated with the transducer. The perforate structure may be in fluid communication with the liquid to be distributed to the atmosphere. It is believed that a resultant pressure differential may be induced in the fluid directly behind the perforate structure. The resulting pressure differential may force the fluid through the perforations to form droplets.

Examining the components in more detail, a liquid reservoir, which contains a liquid to be atomized, may be juxtaposed with and mounted below the electromechanical transducer and orifice plate. The fluid supply component may extend upwardly from within the reservoir to the rear face of the perforate structure. The fluid supply component may lightly touch the perforate structure and particularly may be disposed near the center of the perforate structure so that the fluid supply component may contact the perforations. However, the fluid supply component need not contact the perforations and the perforations may be laterally displaced from the fluid supply component.

The reservoir may comprise any fluid tight container suitable for holding an adequate quantity of the fluid to be dispensed. The reservoir may be pressurized to provide for delivery of the fluid to the perforate structure, or may be maintained at atmospheric pressure. Upon depletion of the reservoir, the reservoir may be refillable with fluid provided from a bulk supply or the reservoir may be replaced with a new reservoir containing a quantity of fluid.

The fluid may be delivered to a perforate structure, which may be a perforate membrane, by a fluid supply component working by gravity feed, capillary action, pumping action, etc.

A continuous feed of the fluid from the reservoir to the perforate structure may be desired. The continuous feed may be accomplished by a using fluid supply component, which may comprise a feed tube that delivers fluid to the rear face of the perforate structure, or to a position juxtaposed with the rear face of the perforate structure. For example, liquid maybe delivered from the reservoir to one face of the perforate structure by a capillary feed. The capillary feed may be flexible and have a surface or assembly of surfaces over which liquid can pass from the supply towards the perforate structure. Exemplary capillary material forms include open cell foams, fibrous wicks, porous plastic wicks, and glass or polymeric capillary tubes.

In applications where relatively high droplet production rates and/or a relatively high percentage of solid are desired, capillary feed may be provided by a relatively open structure, such as an open tube, which may move fluid therethrough by capillary action. This arrangement may provide the advantage of a relatively large, unrestricted area for fluid flow for a given surface area at the wall of the capillary tube. In such a fluid transfer process the area between the capillary material surfaces through which fluid may flow to the capillary surfaces, i.e., fluid volume is relatively large compared to the surface area of the capillary surfaces. This geometry may provide a fluid transfer process which is less restrictive than a similar transfer process utilizing a porous capillary wick. Without being bound by theory, it is believed that an open tube capillary may minimize the interaction between the capillary system porous media and the dispersed solids, thereby allowing the solids to be emitted with the droplets as part of the bulk fluid with minimal liquid to solid separation.

The open capillary tube may be in fluid communication with one or more reservoirs and the transducer or perforate structure. The open capillary tube may have a delivery rate of at least about 20, about 30 or about 40 mg/hr, but is typically not more than about 80, about 70, about 60 or about 50 mg/hr.

The open capillary tube may have a closed cross section, such as a circle. Alternatively, the closed cross section may be non-circular, such as an oval, square, etc. Alternatively, the open capillary tube may comprise an open cross section, such as a channel, weir, etc, having a non-circular or other cross section. The capillary tube may be rigid and made of glass, polymeric materials, etc.

Furthermore, in applications where the droplet production rates in the range of 1 mg/s or more are desired, a flat channel capillary tube may offer the benefit of a relatively greater delivery rate with a simple design and ease of manufacturing. When using a flat channel design consideration may be given to the height of the capillary, since the drag pull on a flat capillary channel is half of that of a capillary tube, resulting in only half of the capillary rise compared to a closed tube.

If desired, plural capillary tubes may be used in parallel to transport liquid from the reservoir to the transducer or perforate structure. If plural capillary tubes are used, the capillary tubes may be of equal or unequal length, cross-sectional area, cross-sectional shape, length, delivery rate, etc. The capillary tubes may have a common or different origin within the reservoir.

Alternatively, plural capillary tubes may be utilized to deliver a like number of plural fluids from separate reservoirs to a common perforate structure. This arrangement provides the advantage that incompatible materials may be kept apart, in discrete reservoirs, until these materials are dispensed at the point of use. The plural materials may be fed from their respective reservoirs to the perforate structure at the same flow rate or at different flow rates

In yet another alternative embodiment having plural reservoirs, plural transducers and a like number of plural perforate structures may be utilized an operated in parallel. This arrangement provides the advantage that no mixing of separate materials occurs until the materials are dispensed into the atmosphere. Again, the materials may be dispensed at a common flow rate or at different flow rates. If so the plural reservoirs, transducers, perforate plates, etc. may be the same or may differ in function and/or performance.

The delivery system or apparatus may comprise an electromechanical transducer, which is an element capable of converting electrical energy to mechanical energy. One known example of an electromechanical transducer comprises piezoelectric materials, which have the ability to change shape when subject to an externally applied voltage. The voltage may cause the transducer to vibrate at certain frequencies.

The transducer may comprise a piezoelectric material, which vibrates at a resonant frequency under an externally applied voltage. The transducer may comprise various shapes and forms, such as a round disc. The transducer may comprise various shapes and forms, such as a round disc. A disc-shaped transducer may have two opposed faces. A separate electrode may be disposed on each face and be radially poled. The electrodes may excite the length modes of the disc shape or a mode of the perforate structure.

A suitable transducer hay be circular, having a diameter of about 10 to about 50 millimeters. In certain embodiments the diameter may be less than about 25 millimeters, less than about 20 millimeters, or may be 15 about millimeters or less. The transducer may have a centrally located orifice therethrough. The orifice may have a diameter of about 5 to about 15 microns. The transducer may be flat and vibrate in a bending mode, with a major excursion generally perpendicular to the opposed faces of the transducer.

The bending may be bilateral or unilateral. A suitable piezoelectric transducer is available from TTP Group plc of Herts, UK.

The electrodes may be patterned so as to incorporate “drive” and “sense” electrodes. The drive and sense electrodes are electrically insulated but mechanically coupled through the piezoelectric transducer. A drive voltage may be applied to the drive electrode. The resulting motion in the transducer generates a voltage at the sense electrode. This voltage can then be monitored and used to control the drive voltage through a feedback circuit. The electrical response may be used to adjust the voltage to achieve specified resonances either by phase locking, amplitude maximizing or other known means. In order to maximize the electromechanical coupling to the desired mode it may be useful to shape the drive electrode appropriately.

The induced vibration may have an amplitude and phase induced in relation to characteristics of the drive signal. If desired, the drive voltage may sweep various frequencies, to provide a range of dispensing characteristics. Alternatively, the drive voltage may excite the transducer at a single frequency. The single frequency may be coincident or near the transducer's natural frequency or a harmonic thereof. This arrangement may provide the benefit that less power is consumed than using a sweep of multiple frequencies over a spectrum.

In order to improve the efficiency of the operation it may also be useful to incorporate a sense electrode into the design. This sense electrode can give phase and amplitude information that allows an appropriate electronic circuit to lock on to the correct resonant mode. It may be advantageous to shape the sense electrode so as to achieve appropriate electromechanical coupling.

The perforate structure may be formed from a variety of materials including electro formed nickel, etched silicon, stainless steel or plastics. The perforate structure may be flexible or stiff. A flexible design is one where the amplitudes of the vibrational modes of the perforate structure are large compared with those of the electromechanical transducer. The resulting motion may have a significant effect on the droplet generation process. A stiff design is one where the amplitudes of the vibrational modes of the perforate structure are generally equal to or smaller than those of the electromechanical transducer. This motion, generally, follows the motion of the electromechanical transducer. In either design, the flexibility may be controlled by a choice of material and thickness. The benefit of the stiff design is that a stiff perforate structure may give uniform droplet ejection across its surface without causing a dampening of the overall motion.

The perforate structure may be joined to one face of the electromechanical transducer by adhesive, solder, etc. The perforate structure may comprise plural orifices disposed on a pattern, such as a hexagonal lattice. The droplet size may be determined by varying the cross sectional area of the exit of the orifice. For a round orifice, the orifice may have a diameter of about 1 to about 100 microns. In one embodiment, the diameter of the orifices may be less than about 30 microns. In another embodiment, the diameter of the orifices may be less than about 15 microns, and particularly between about 2 to about 10 microns.

The perforations may be tapered to have a reduction in cross-sectional area in the flow direction. If a perforate structure having perforations of variable cross section is selected, the cross sectional area of the perforations may decrease from the rear face to the front face of the perforate structure. Such a tapered orifice may reduce the amplitude of vibration of the perforate structure which is necessary in order to produce droplets of a given size, due to the reduction of viscous drag upon the liquid as it passes through such perforations. Consequently, a relatively lower excitation of the electromechanic transducer may be used, thereby providing improved efficiency in creating the droplets to be dispensed. The relatively lesser excitation may enable the use of relatively thick and robust perforate structure from which satisfactory droplet production can be achieved, the successful creation of droplets from liquids of relatively high viscosity and may reduce the mechanical stresses in the perforate structure.

The device may have a first, disposable part, comprising the fluid and its container or fluid reservoir. The second part, may be reusable, and may comprise the electromechanical transducer, the perforate structure with its associated drive electronics and a power source. This provides a system which is refillable. Alternatively, the system may be discarded upon depletion of the reservoir.

Suitable devices and methods of their operation are known in the art and maybe made according to the teachings of U.S. patent applications Ser. No. 11/273,461 filed Nov. 14, 2005, and 2001/0042794 A1, and/or U.S. Pat. Nos. 6,293,474 B1, 6,296,196 B1 and 6,921,020 B2.

The device can be operated from any suitable power supply. The power may be supplied from an internal power source, such as an electric battery, solar photovoltaic conversion, etc. or by plugging into a wall outlet.

If desired, the device may further include an air pump or fan, to improve dispersion of the perfume throughout the environment. For a perfume having a solids content of at least about 3 percent, a fan providing airflow of at least about 0.057 or 0.085 cubic meters per minute may be utilized. Typically the fan need not have an airflow greater than 0.142 or 0.113 cubic meters per minute.

The fan may be angled at least 15 or at least 26 degrees from the horizontal, although angles greater than 55 or 40 degrees from the horizontal are typically unnecessary. As the angle of the fan approaches the horizontal, a higher flow rate may be helpful to provide adequate dispersion of the perfume.

The device may further comprise an automatic switch, as is known in the art. The automatic switch may activate or deactivate the device when a threshold amount of energy is or is not present. For example, the automatic switch may comprise a photocell. The photocell may cause the device to shut down, when a threshold amount of light is not present. This allows the device to shut down at night, in case people are not present during the evening. The photocell may shut down the either the fan, electromechanical transducer, or both. Alternatively, the device, transducer and/or fan may be activated by, or be rendered inactive by, the presence or absence of sound, motion, heat or other energy forms.

### EXAMPLE 1

Example 1 compares a relatively low solids content perfume formulation to a corresponding relatively high solids content perfume formulation using a piezoelectric delivery system according to the following Sensory Evaluation Method for delivery systems or apparatus.

A dedicated odor evaluation room is utilized for all sensory evaluations. A trained odor evaluator verifies that there is not any residual perfume or room odor present in the room. The door(s) to the room are closed and the delivery system or apparatus is activated by a test facilitator. Trained odor evaluators enter the odor evaluation room and perform odor evaluations at the following time intervals: (1) 3 minutes after activation (2) 6 minutes after activation (3) 12 minutes after activation and (4) 18 minutes after activation. The sensory evaluations are conducted at the following distances from the delivery system or apparatus starting at the furthest distance: (1) 0.9 meters (2) 1.8 meters and (3) 2.7 meters. Expert evaluators exit the room between odor evaluations and the door(s) are closed between odor evaluations. Expert evaluators provide odor intensity measurements on a sensory rating scale of 0-5.

Perfume Intensity Scale:

5=very strong, i.e., extremely overpowering,

4=strong, i.e., very room filling, but slightly overpowering

3=moderate, i.e., room filling, odor character clearly recognizable

2=light, i.e., fills part of the room, with recognizable odor character

1=weak, i.e., diffusion is limited, odor character difficult to describe,

0=no scent

Table 1 illustrates the improved perfume hedonic data at all distances from the device when the piezoelectric delivery system contains a high solid perfume formulation. This translates to the consumer as better perfume intensity and character.

TABLE 1

| | Perfume intensity grade at given distance from the | | |
|---|---|---|---|
| | device | | |
| | 0.9 meters | 1.8 meters | 2.7 meters |
| 2 percent solids | 1.5 | 1.5 | 1.0 |
| 3 percent solids | 3.0 | 2.5 | 2.0 |

A formulation with a higher percentage of solids, particularly when used in a system with a open tube capillary feed, may deliver a higher intensity, more complex perfume character and a more substantive perfume presentation than a corresponding perfume having a lower solids content.

While particular embodiments of the subject invention have been described, it will be apparent to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A device for generating droplets of fluid, the device comprising:
a reservoir containing a liquid formulation; and
an electromechanical transducer for generating droplets of said liquid upon excitation by a power supply, said transducer being in fluid communication with liquid formulation;
wherein said liquid formulation contains about 3 to about 30 weight percent solids.

2. A device according to claim 1, wherein the liquid formulation comprises a perfume composition.

3. A device according to claim 1, wherein the liquid formulation contains at least about 4 percent and not more than about 25 percent solids.

4. A device according to claim 3, Wherein the liquid formulation contains at least about 6 percent and not more than about 25 percent of dissolved solids

5. A device according to claim 4, wherein the liquid formulation contains at least about 10 percent and not more than about 25 percent of dissolved solids.

6. A device according to claim 5, wherein the liquid formulation contains at least about 10 percent and not more than about 20 percent of dissolved solids.

7. A device according to claim 6, wherein the liquid formulation contains at least about 10 percent and not more than about 16 percent of dissolved solids.

8. A device according to claim 1, wherein the liquid formulation is supplied to the transducer fluid via a capillary action, using an open capillary tube.

9. A device according to claim 8 wherein said open capillary tube has a closed, non-circular cross section.

10. A device according to claim 9 having a delivery rate of the liquid formulation of at least about 30 mg/hr.

11. A device according to claim 1, wherein the electromechanical transducer comprises a disc shaped piezoelectric element, said element being driven at its resonant frequency by a drive electrode and a sense electrode.

12. A device according to claim 11, wherein the droplet generation element comprises a perforate structure having tapered perforations.

13. A device according to claim 1, the device comprising:
a plurality of fluid supply components, each said fluid supply component being in fluid communication with one or more reservoirs containing liquid therein; and
a plurality of droplet generation elements, coupled for movement with one or more electromechanical transducers and in fluid communication with said liquids of said reservoirs.

14. A device according to claim 1 further comprising a fan for dispersion of the droplets, the fan being oriented at an angle of 15 to 50 degrees from the horizontal.

15. A device according to claim 14 wherein said fan is oriented at an angle of 26 to 40 degrees from the horizontal.

16. A device according to claim 1 which is powered from an internal power source.

17. A device according to 14 further comprising an automatic switch for controlling the transducer and/or fan in response to the presence or absence of a threshold amount of energy.

18. A device according to 17 wherein said automatic switch comprises a photocell.

19. A device for generating droplets of fluid, the device comprising:
a) an open capillary tube which having an open cross section or a closed non-circular cross section said tube being in fluid communication with a reservoir containing a liquid formulation;
b) an electromechanical transducer in fluid communication with said tube;
c) a droplet generation element, coupled for movement with the electromechanical transducer and positioned for contact with said fluid; and
wherein said liquid formulation contains about 3 percent to about 25 percent of dissolved solids and wherein said device is capable of operating from an internal power source.
